(19) United States
(12) Patent Application Publication
(10) Pub. No.: US 2020/0136215 A1
(43) Pub. Date: Apr. 30, 2020

(54) LITHIUM-ION POWER BATTERY

(71) Applicant: CHANGSHA JUNENGCHONG NEW ENERGY CO., LTD, Changsha (CN)

(72) Inventor: BO-QIAN QIU, Changsha (CN)

(21) Appl. No.: 16/728,958

(22) Filed: Dec. 27, 2019

Related U.S. Application Data
(63) Continuation of application No. PCT/CN2018/093106, filed on Jun. 27, 2018.

(30) Foreign Application Priority Data
Jun. 28, 2017 (CN) 201710503558.5
Jun. 28, 2017 (CN) 201710503601.8
Jun. 28, 2017 (CN) 201710503721.8

(51) Int. Cl. H01M 10/6567; H01M 10/0525; H01M 10/653; H01M 10/6551; H01M 10/6552; H01M 10/6556

(52) U.S. Cl. CPC H01M 10/6567; H01M 10/0525; H01M 10/6556; H01M 10/6551; H01M 10/6552; H01M 10/653

(57) ABSTRACT

A lithium-ion power battery includes at least one battery cell each having a positive electrode plate and a negative electrode plate. Each battery cell includes at least two heat conducting and collecting bodies formed on at least one of the positive electrode plate and the negative electrode plate. Each heat conducting and collecting body is a portion of the positive current collector not coated by the positive active material layer or a portion of the negative current collector not coated by the negative active material layer. The heat conducting and collecting bodies are stacked together to form at least one heat converging path. A fluid-containing pipe is connected to the at least one heat converging path. A connector is disposed at each of an inlet and an outlet of the fluid-containing pipe, for connecting the fluid-containing pipe to an external component.

### CROSS-REFERENCE TO RELATED APPLICATIONS

This application claims all benefits accruing under 35 U.S.C. § 119 from China Patent Application No. 201710503601.8, filed on Jun. 28, 2017, China Patent Application No. 201710503721.8, filed on Jun. 28, 2017, and China Patent Application No. 201710503558.5, filed on Jun. 28, 2017, in the China National Intellectual Property Administration, the entire contents of which are hereby incorporated by reference. This application is a continuation under 35 U.S.C. § 120 of international patent application PCT/CN2018/093106 filed Jun. 27, 2018.

### FIELD

The subject matter herein generally relates to lithium-ion batteries, and more particularly, to a lithium-ion power battery.

### BACKGROUND

Traffic on the roads brings pressure on the energy crisis and environmental pollution, thus it is urgent to develop and research vehicles powered by efficient, clean and safe energy to achieve energy conservation and emission reduction. Lithium-ion batteries have become the best candidates for power systems of the new energy vehicles because of high specific energy, no pollution, and no memory effect of the lithium-ion batteries. However, the lithium-ion batteries are very sensitive to temperature, and efficient discharge and good performance of the battery pack can be only obtained within a suitable temperature range. Operating at an elevated temperature may cause the lithium-ion battery to age faster and increase its thermal resistances faster. Furthermore, the cycling time becomes less, the service life becomes shorter, and even thermal runaway problems occur at an elevated operating temperature. However, operating at too low a temperature may lower the conductivity of the electrolyte and the ability to conduct active ions, resulting an increase of the impedance, and a decrease in the capacity of the lithium-ion batteries.

Conventionally, the cell is positioned to improve the fluid flow path and increase the heat dissipation. The battery casing may also be improved by replacing the aluminum alloy shell material with the composite of thermoelectric material and aluminum, and by adding a plurality of heat dissipating ribs to the side of the battery casing. The electrode plate may also be extended into the electrolyte to transmit heat energy to the battery casing through the electrolyte and then to the outside environment. Although some heat is dissipated, the heat dissipation efficiency is generally low because the heat cannot be directly discharged from the electrode plates, the main heat generating component, to the outside environment. Therefore, a new design of a lithium-ion power battery is desired.

### BRIEF DESCRIPTION OF THE DRAWINGS

FIG. 1 is a schematic view of a lithium-ion power battery in a first embodiment according to the present disclosure.

FIG. 2 is a schematic view of a battery cell of the lithium-ion power battery of FIG. 1.

FIG. 3 is a cross-sectional view of the battery cell of FIG. 2.

FIG. 4A is a cross-sectional view of a positive electrode plate of the battery cell of FIG. 3.

FIG. 4B is a cross-sectional view of a negative electrode plate of the battery cell of FIG. 3.

FIG. 5 is a cross-sectional view of the lithium-ion power battery of FIG. 1.

FIG. 6 is a cross-sectional view of a lithium-ion power battery in a second embodiment according to the present disclosure.

FIG. 7 is a cross-sectional view of a lithium-ion power battery in a third embodiment according to the present disclosure.

FIG. 8 is a cross-sectional view of a lithium-ion power battery in a fourth embodiment according to the present disclosure.

FIG. 9 is a cross-sectional view of a lithium-ion power battery in a fifth embodiment according to the present disclosure.

FIG. 10 is a cross-sectional view of a lithium-ion power battery in a sixth embodiment according to the present disclosure.

FIG. 11 is a cross-sectional view of a lithium-ion power battery in a seventh embodiment according to the present disclosure.

FIG. 12 is a cross-sectional view of a lithium-ion power battery in an eighth embodiment according to the present disclosure.

FIG. 13 is a cross-sectional view of a lithium-ion power battery in a ninth embodiment according to the present disclosure.

### DETAILED DESCRIPTION

Implementations of the disclosure will now be described, by way of embodiments only, with reference to the drawings.

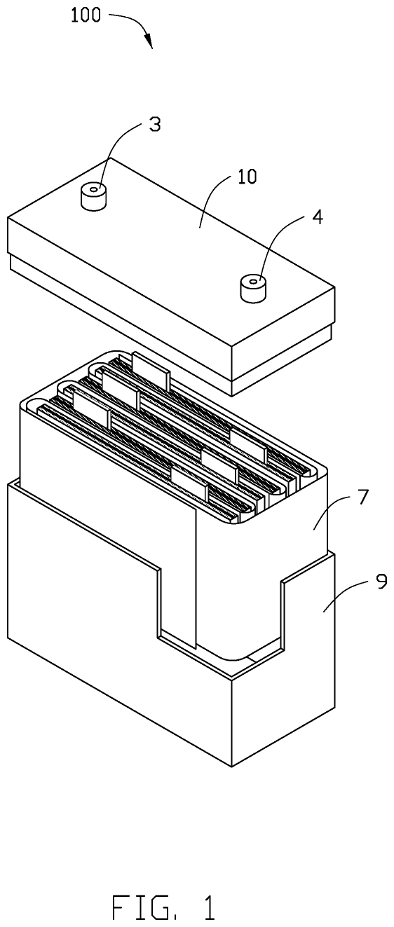

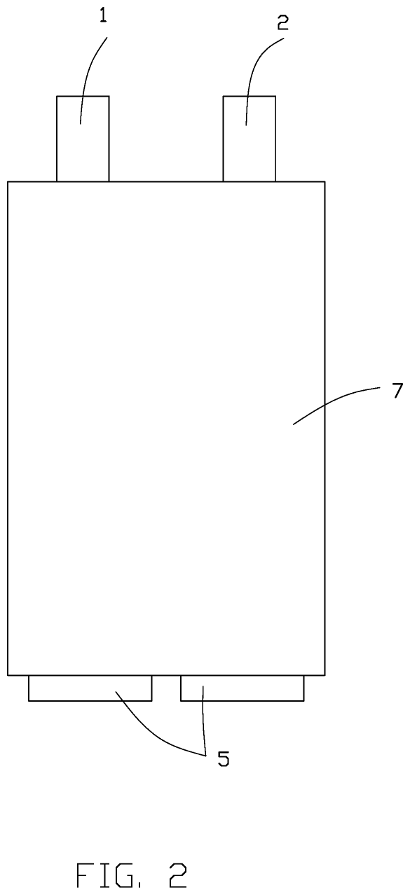

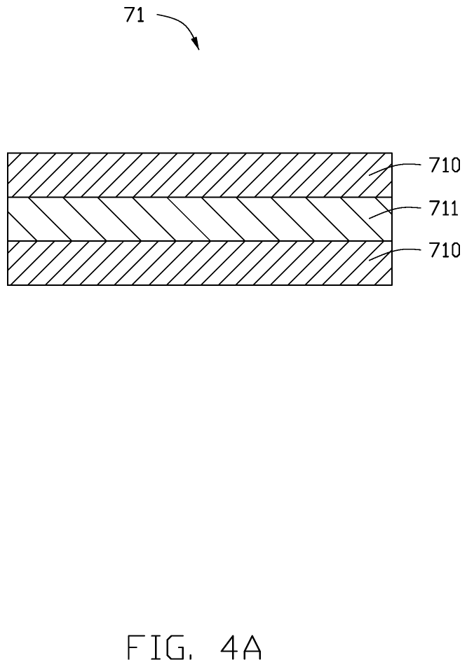

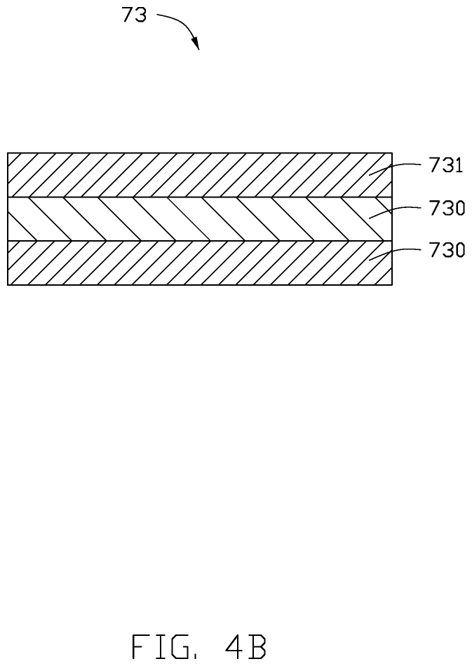

FIGS. 1 to 5 illustrate a first embodiment of a lithium-ion power battery 100 comprising at least one battery cell 7, a metallic casing 9 for receiving the battery cell 7, an electrolyte 12 injected into the metallic casing 9, and a top cover 10 connected to the metallic casing 9. The battery cell 7 comprises a positive electrode plate 71, a negative electrode plate 73, and a separator 72 spaced between the positive electrode plate 71 and the negative electrode plate 73. The positive electrode plate 71, the separator 72, and the negative electrode plate 73 are sequentially laminated together and then wound together to form the battery cell 7. The positive electrode plate 71 comprises a positive electrode tab 1. The negative electrode plate 73 comprises a negative electrode tab 2. The top cover 10 comprises a positive terminal post 3 electrically connected to the positive terminal tab 1 and a negative terminal post 4 electrically connected to the negative electrode tab 2. Referring to FIG. 4A, the positive electrode plate 71 comprises a positive current collector 711 and two positive active material layers 710 coated on the positive current collector 711. Referring to FIG. 4B, the negative electrode plate 73 comprises a negative current collector 731 and two negative active material layers 730 coated on the negative current collector 731.

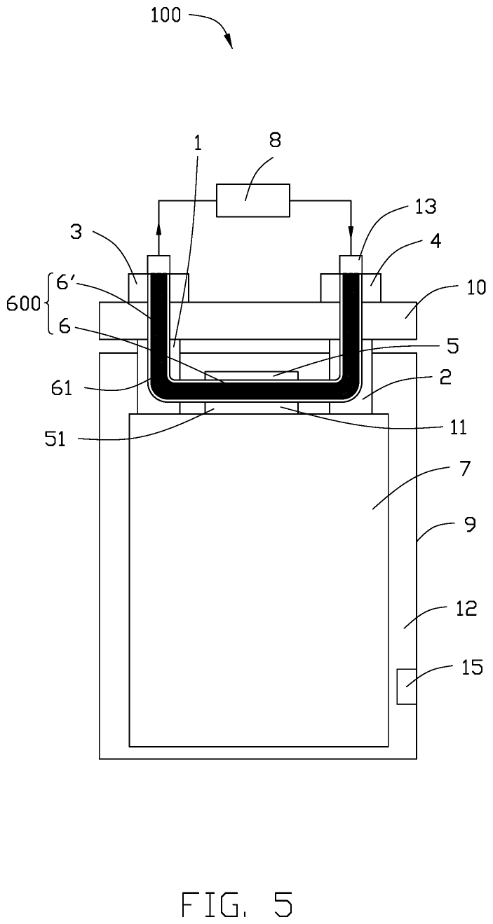

Each battery cell 7 comprises at least two heat conducting and collecting bodies 5 formed on the positive electrode plate 41 and the negative electrode plate 43. Each heat conducting and collecting body 5 is a portion of the positive current collector 711 not coated by the positive active material layer 710 or a portion of the negative current collector 731 not coated by the negative active material layer 730. The at least two heat conducting and collecting bodies 5 are stacked together to form at least one heat converging path 11, which is configured to transmit heat energy into or out of the battery cell 7. A fluid-containing branched pipe 6 is disposed on the heat converging path 11 of each battery cell 7. Referring to FIG. 5, a fluid-containing main pipe 6′ is disposed on the metallic casing 9 or the top cover 10. Each fluid-containing branched pipe 6 is jointed to the fluid-containing main pipe 6′ to form a fluid-containing pipe 600, which can balance the temperatures among different battery cells 7. A connector 13 is disposed at each of an inlet and an outlet of the fluid-containing pipe 600, for connecting the fluid-containing pipe 600 to an external component (for example, a first heat exchanging device 8). The connector 13 protrudes from the metallic casing 9 and the top cover 10.

Since the heat conducting and collecting bodies 5 are integrally formed with the positive electrode plate 71 and the negative electrode plate 73, the manufacturing process is simplified, and the manufacturing efficiency is increased. By stacking the heat conducting and collecting bodies 5 to form the heat converging path 11 and heating or cooling the heat converging path 11 through the fluid-containing pipe 600, the internal temperature of the battery 100 is increased or decreased, thereby maintaining the temperature of the battery 100 within a suitable range. Thus, the working efficiency and the service life of the battery 100 are increased, and potential safety hazards are avoided. The connector 13 protruding from the metallic casing 9 and the top cover 10 can facilitate the connection between the fluid-containing pipe 600 and the external component.

The fluid-containing pipe 600 can be a pipe containing fluid or an air conditioning refrigerant. The fluid-containing pipe 600 can also be a heat pipe comprising a pipe casing and a wick structure in the pipe casing.

In at least one embodiment, the heat conducting and collecting bodies 5 are connected together by welding, thereby forming the heat converging path 11. The welding allows the connection of the heat conducting and collecting bodies 5 to be stable, which can reduce the weight and increase the energy density of the battery 100. The welding can be ultrasonic welding, laser welding, or friction welding. In another embodiment, the heat conducting and collecting bodies 5 can also be connected together by bolting or riveting. The bolting or the riveting will not cause damages to the separator 72.

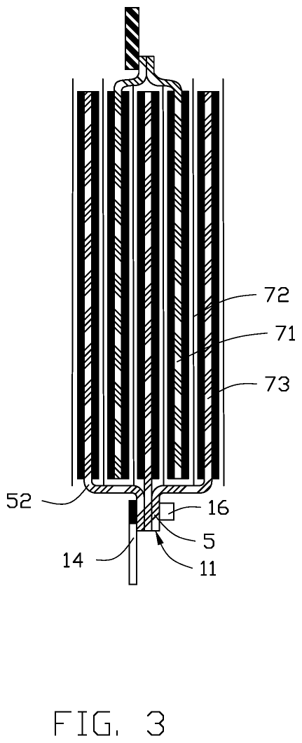

Moreover, referring to FIG. 3, the heat conducting and collecting bodies 5 are bent towards each other before connected together. Therefore, the heat absorbed by the heat conducting and collecting bodies 5 is converged, which facilitates cooling or heating of the battery 100. The heat conducting and collecting bodies 5 can be bent to be inclined with the positive electrode plate 71 or the negative electrode plate 73 by an angle between 0 degree to 90 degrees. The heat conducting and collecting bodies 5 can be bent toward different directions (for example, the bending direction of a portion of the heat conducting and collecting bodies 5 being opposite to that of the remaining heat conducting and collecting bodies 5). The entirety of the heat conducting and collecting bodies 5 can also be bent toward a single direction, which facilitates the connection of the heat conducting and collecting bodies 5. In other embodiments, a portion of the heat conducting and collecting bodies 5 are bent toward a single direction or different directions, and the portion is connected to the remaining portion of the heat conducting and collecting bodies 5, the remaining portion of the heat conducting and collecting bodies 5 is straight (unbent). The heat conducting and collecting bodies 5 being bent towards a single direction can simplify the manufacturing process, while being bent towards different directions can improve the contact effect therebetween.

In other embodiments, the heat conducting and collecting bodies 5 can also be parallel to the positive active material layers 710. That is, the heat conducting and collecting bodies 5 are not bent towards each other.

At least a portion of the heat conducting and collecting bodies 5 defines a plurality of holes (not shown), which can increase the surface area of the heat conducting and collecting bodies 5. The holes can pass through the heat conducting and collecting body 5, and have a mesh structure or a 3D internal structure. In another embodiment, at least a portion of the heat conducting and collecting bodies 5 can define a concave and/or convex surface. As such, the surface area of the heat conducting and collecting body 5 is increased, which facilitates the cooling and the heating.

In at least one embodiment, the heat conducting and collecting body 5 can have a first insulating layer 51 on a surface thereof. As such, a short circuit at the heat conducting and collecting bodies 5 can be avoided. Potential safety hazards can further be avoided. Furthermore, a second insulating layer 61 is disposed on an inner wall of the fluid-containing pipe 600. In another embodiment, the second insulating layer 61 can also be disposed at the joint between the fluid-containing branched pipe 6 and the fluid-containing main pipe 6′. As such, a short circuit at the fluid-containing pipe 600 can be avoided. Potential safety hazards can further be avoided. A plurality of fins (not shown) can also be disposed in the fluid-containing pipe 600 for conducting heat.

In at least one embodiment, a second heat exchanging device 14 is disposed on the heat converging path 11. The second heat exchanging device 14 is further inserted into the electrolyte 12 in the metallic casing 9. As such, the heat energy can be conducted between the heat converging path 11 and the electrolyte 12. Thus, the temperature of the battery 100 is controlled, thereby maintaining the temperature of the battery 100 within a suitable range. The second heat exchanging device 14 can be fins or metal sheets.

The heat conducting and collecting body 5 can protrude from the positive electrode plate 71 and the negative electrode plate 73, which facilitates the conduction and dissipation of the heat energy. Portions of the heat conducting and collecting body 5 protruding from the positive electrode plate 71 and the negative electrode plate 73 is further inserted into the electrolyte 12 received in the metallic casing 9. As such, the heat energy from the heat conducting and collecting body 5 can be conducted into the electrolyte 12 and further to the external surface of the battery 100. Therefore, the heat energy is prevented from being accumulated in the battery 100 due to poor heat conduction of the separator 72. Furthermore, the heat energy in the electrolyte 12 can further quickly move to the positive and the negative electrode plates 71, 73, which prevents the temperature of the positive and the negative electrode plates 71, 73 from being too low. In another embodiment, the heat conducting and collecting body 5 can also be recessed with respect to the positive and the negative electrode plates 71, 73, which reduces the weight and increase the energy density of the battery 100.

Furthermore, a third heat exchanging device 15 is disposed in the electrolyte 12 for heating or cooling the electrolyte 12. The electrolyte 12 can in turn heat or cool the heat conducting and collecting bodies 5, thereby maintaining the temperature of the battery 100 within a suitable range.

In an embodiment, an interconnecting portion 52 is formed between the heat conducting and collecting body 5 and the positive and the negative electrode plates 71, 73. A thickness of the entirety of the heat conducting and collecting body 5 is same of that of the interconnecting portion 55. As such, the heat conducting and collecting body 5 and the electrode plate can have a greatest interconnecting area therebetween in case of a certain size, which results in a best conducting property.

In at least one embodiment, a first temperature sensor 16 is disposed on the heat converging path 11, which can sense the temperature of the heat converging path 11. Thus, the temperature of the heat converging path 11 can be controlled accordingly. The first temperature sensor 16 can be a thin-film temperature sensor.

In at least one embodiment, the positive active material of the positive active material layer 710 is lithium iron phosphate, lithium cobalt oxide, lithium manganate, or a ternary material. The negative active material of the negative active material layers 730 is carbon, tin-based negative material, transition metal nitride containing lithium or alloy.

Referring to FIG. 5, in the first embodiment, the positive electrode tab 1 and the negative electrode tab 2 are disposed at the same end of the battery 100. The heat conducting and collecting bodies 5 are disposed at the same end of the battery 100. The fluid-containing pipe 600 is inserted into the center the negative terminal post 4 and the positive terminal post 3. The inlet and the outlet of the fluid-containing pipe 600 are formed in the center of the negative terminal post 4 and the center of the positive terminal post 3, respectively. In another embodiment, the inlet and the outlet of the fluid-containing pipe 600 can also be formed in the center of the positive terminal post 3 and the center of the negative terminal post 4, respectively. The first heat exchanging device 8 outside the metallic casing 9 and the fluid-containing pipe 600 cooperatively form a complete energy cycle.

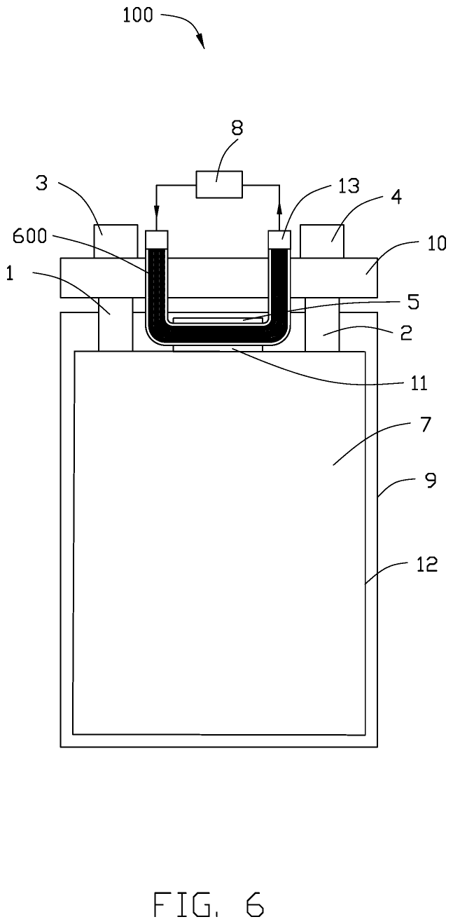

Referring to FIG. 6, in a second embodiment, the positive electrode tab 1 and the negative electrode tab 2 are disposed at the same end of the battery 100. The heat conducting and collecting bodies 5 are disposed at the same end of the battery 100. The fluid-containing pipe 600 is inserted into the top cover 10. The inlet and the outlet of the fluid-containing pipe 600 are disposed at different positions of top cover 10. The heat first exchanging device 8 outside the metallic casing 9 and the fluid-containing pipe 600 cooperatively form a complete energy cycle.

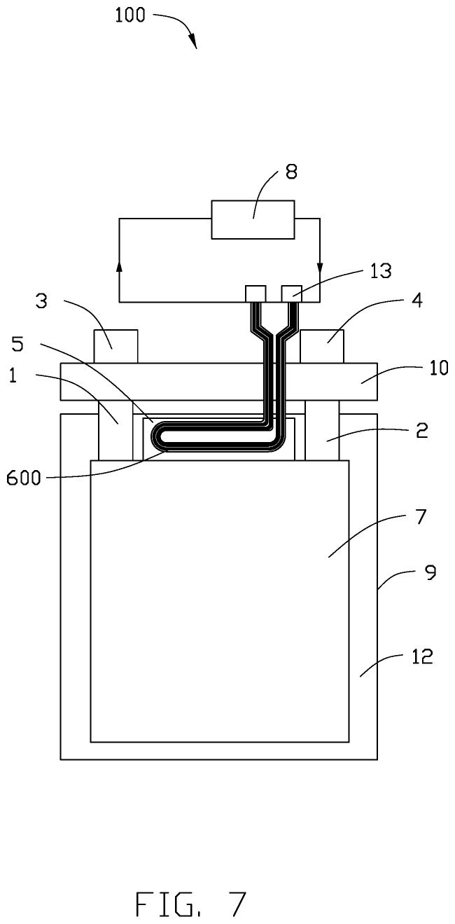

Referring to FIG. 7, in a third embodiment, the positive electrode tab 1 and the negative electrode tab 2 are disposed at the same end of the battery 100. The heat conducting and collecting bodies 5 are disposed at the same end of the battery 100. The fluid-containing pipe 600 is inserted into the top cover 10. The inlet and the outlet of the fluid-containing pipe 600 are disposed at a same position of top cover 10. The first heat exchanging device 8 outside the metallic casing 9 and the fluid-containing pipe 600 cooperatively form a complete energy cycle.

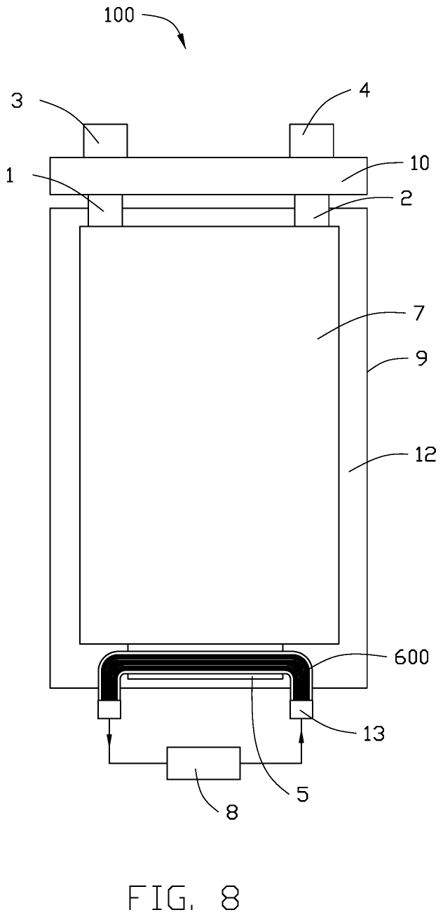

Referring to FIG. 8, in a fourth embodiment, the positive electrode tab 1 and the negative electrode tab 2 are disposed at the same end of the battery 100. The heat conducting and collecting bodies 5 are disposed at the opposite end of the battery 100. The fluid-containing pipe 600 is inserted into the bottom end of the metallic casing 9. The inlet and the outlet of the fluid-containing pipe 600 are disposed at different positions of the metallic casing 9. The first heat exchanging device 8 outside the metallic casing 9 and the fluid-containing pipe 600 cooperatively form a complete energy cycle.

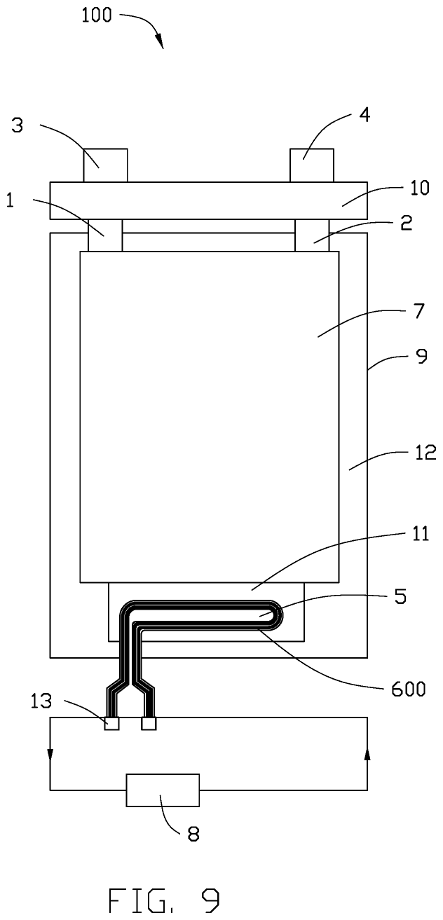

Referring to FIG. 9, in a fifth embodiment, the positive electrode tab 1 and the negative electrode tab 2 are disposed at the same end of the battery 100. The heat conducting and collecting bodies 5 are disposed at the opposite end of the battery 100. The fluid-containing pipe 600 is inserted into the bottom end of the metallic casing 9. The inlet and the outlet of the fluid-containing pipe 600 are disposed at the same position of the metallic casing 9. The first heat exchanging device 8 outside the metallic casing 9 and the fluid-containing pipe 600 cooperatively form a complete energy cycle.

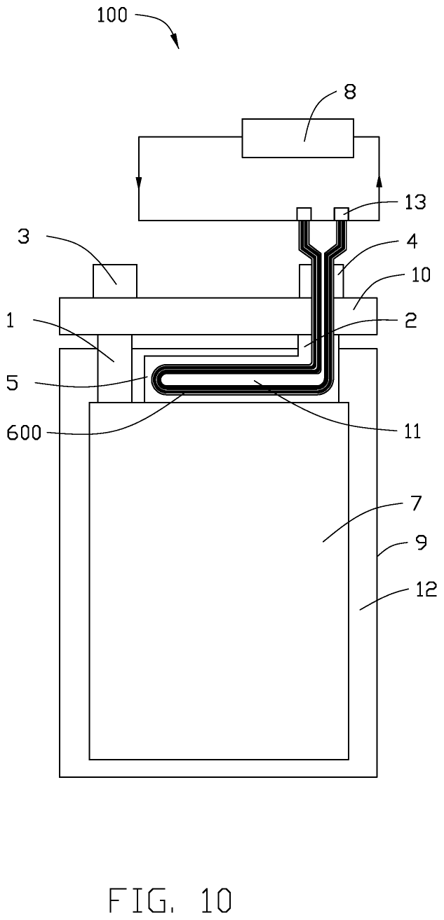

Referring to FIG. 10, in a sixth embodiment, the positive electrode tab 1 and the negative electrode tab 2 are disposed at the same end of the battery 100. The heat conducting and collecting bodies 5 are disposed at the same end of the battery 100. The fluid-containing pipe 600 is inserted into the center the negative terminal post 4. The inlet and the outlet of the fluid-containing pipe 600 are both disposed at the negative terminal post 4. In another embodiment, the inlet and the outlet of the fluid-containing pipe 600 can also be disposed at the positive terminal post 3. The first heat exchanging device 8 outside the metallic casing 9 and the fluid-containing pipe 600 cooperatively form a complete energy cycle.

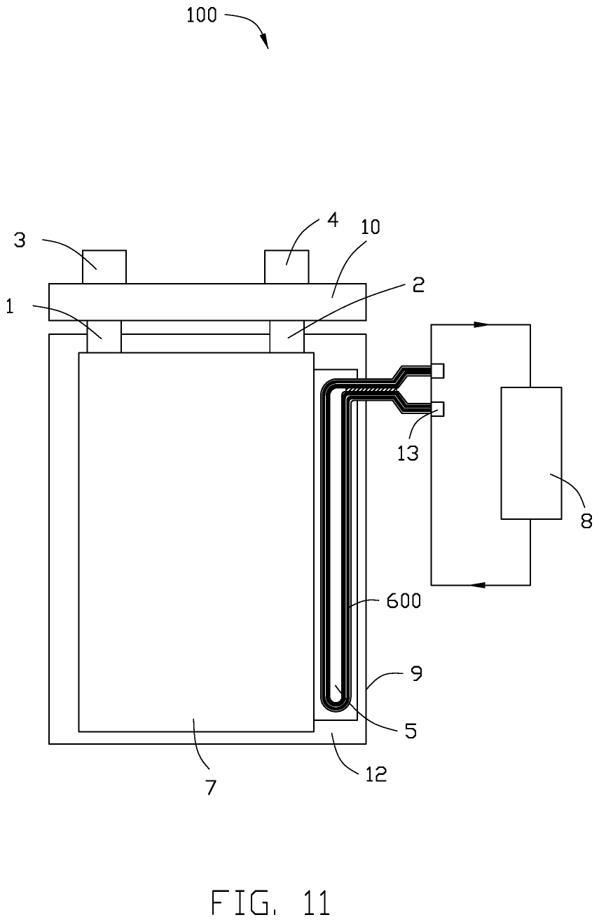

Referring to FIG. 11, in a seventh embodiment, the positive electrode tab 1 and the negative electrode tab 2 are disposed at the same end of the battery 100. The heat conducting and collecting bodies 5 are disposed at the side of the battery 100. The fluid-containing pipe 600 is inserted into the side of the metallic casing 9. The inlet and the outlet of the fluid-containing pipe 600 are disposed at a same position of the metallic casing 9. The first heat exchanging device 8 outside the metallic casing 9 and the fluid-containing pipe 600 cooperatively form a complete energy cycle.

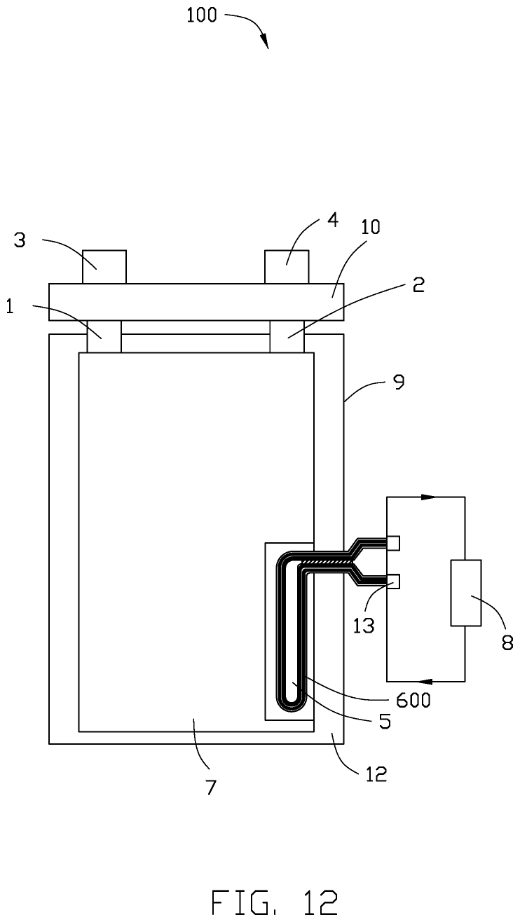

Referring to FIG. 12, in an eighth embodiment, the positive electrode tab 1 and the negative electrode tab 2 are disposed at the same end of the battery 100. The heat conducting and collecting bodies 5 are disposed at the side of the battery 100, and is recessed with respect to the electrode plates. The fluid-containing pipe 600 is inserted into the side of the metallic casing 9. The first heat exchanging device 8 outside the metallic casing 9 and the fluid-containing pipe 600 cooperatively form a complete energy cycle.

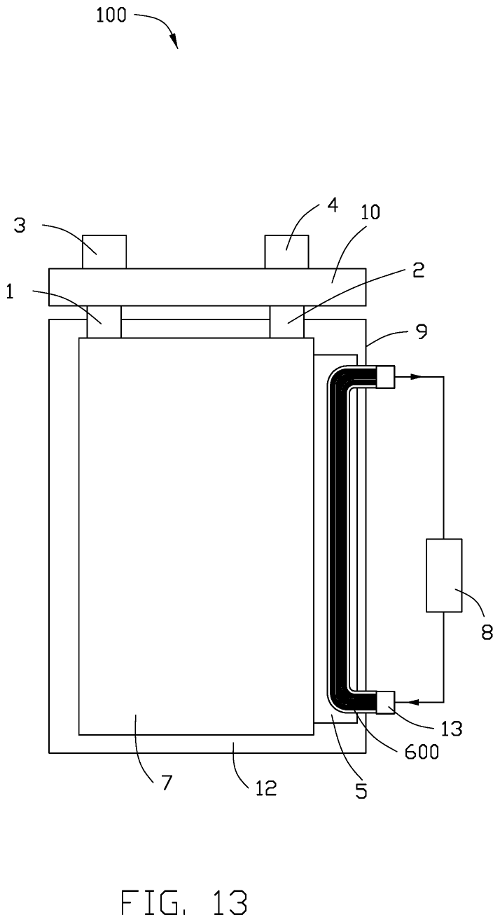

Referring to FIG. 13, in a ninth embodiment, the positive electrode tab 1 and the negative electrode tab 2 are disposed at the same end of the battery 100. The heat conducting and collecting bodies 5 are disposed at a side of the battery 100. The fluid-containing pipe 600 is inserted into the side of the metallic casing 9. The inlet and the outlet of the fluid-containing pipe 600 are disposed at different positions of the metallic casing 9. The first heat exchanging device 8 outside the metallic casing 9 and the fluid-containing pipe 600 cooperatively form a complete energy cycle.

Implementations of the above disclosure will now be described by way of embodiments only. It should be noted that devices and structures not described in detail are understood to be implemented by the general equipment and methods available in the art.

It is to be understood, even though information and advantages of the present embodiments have been set forth in the foregoing description, together with details of the structures and functions of the present embodiments, the disclosure is illustrative only; changes may be made in detail, especially in matters of shape, size, and arrangement of parts within the principles of the present embodiments to the full extent indicated by the plain meaning of the terms in which the appended claims are expressed.

What is claimed is:

1. A lithium-ion power battery comprising:
at least one battery cell each comprising a positive electrode plate and a negative electrode plate, the negative electrode plate comprising a negative current collector and a negative active material layer coated on the negative current collector, the positive electrode plate comprising a positive current collector and a positive active material layer coated on the positive current collector,
wherein each of the at least one battery cell comprises at least two heat conducting and collecting bodies formed on at least one of the positive electrode plate and the negative electrode plate, each of the heat conducting and collecting bodies being a portion of the positive current collector which is not coated by the positive active material layer or a portion of the negative current collector which is not coated by the negative active material layer;
wherein the at least two heat conducting and collecting bodies are stacked together to form at least one heat converging path, which being configured to transmit heat energy into or out of the battery cell;
wherein a fluid-containing pipe is connected to the at least one heat converging path; and
wherein a connector is disposed at each of an inlet and an outlet of the fluid-containing pipe, the connector connecting the fluid-containing pipe to an external component.

2. The lithium-ion soft battery of claim 1, further comprising a metallic casing configured for receiving the at least one battery cell and a top cover connected to the metallic casing, wherein a fluid-containing branched pipe is disposed on the heat converging path of each of the at least one battery cell, a fluid-containing main pipe is disposed on the metallic casing or the top cover, each fluid-containing branched pipe is jointed to the fluid-containing main pipe to form the fluid-containing pipe.

3. The lithium-ion soft battery of claim 2, wherein the connector protrudes from the metallic casing and the top cover.

4. The lithium-ion soft battery of claim 1, wherein the at least two heat conducting and collecting bodies are connected by welding, bolting, or riveting.

5. The lithium-ion soft battery of claim 1, wherein the at least two heat conducting and collecting bodies are bent towards each other.

6. The lithium-ion soft battery of claim 5, wherein the at least two heat conducting and collecting bodies are bent to be inclined with the positive electrode plate or the negative electrode plate by an angle between 0 degree to 90 degrees.

7. The lithium-ion soft battery of claim 5, wherein the at least two heat conducting and collecting bodies are bent toward different directions or a single direction.

8. The lithium-ion soft battery of claim 1, wherein a portion of each of the at least two heat conducting and collecting bodies is bent toward a single direction or different directions, and the portion which is bent is connected to a remaining portion of the at least two heat conducting and collecting bodies, the remaining portion of each of the heat conducting and collecting bodies is straight.

9. The lithium-ion soft battery of claim 1, wherein at least a portion of each of the at least two heat conducting and collecting bodies defines a plurality of holes or a concave and convex surface.

10. The lithium-ion soft battery of claim 1, wherein each of the at least two heat conducting and collecting bodies comprises a first insulating layer on a surface thereof.

11. The lithium-ion soft battery of claim 1, wherein the fluid-containing pipe comprises a second insulating layer disposed on an inner wall of the fluid-containing pipe.

12. The lithium-ion soft battery of claim 2, wherein the fluid-containing pipe comprises a second insulating layer disposed on a joint between the fluid-containing branched pipe and the fluid-containing main pipe.

13. The lithium-ion soft battery of claim 1, wherein each of the at least two heat conducting and collecting bodies protrudes from the positive electrode plate, and portions of the at least two heat conducting and collecting bodies which protrude from the positive electrode plate are inserted into an electrolyte of the lithium-ion soft battery.

14. The lithium-ion soft battery of claim 12, further comprising a heat exchanging device disposed in the electrolyte, wherein the heat exchanging device heats or cools the electrolyte.

15. The lithium-ion soft battery of claim 1, further comprising a heat exchanging device disposed on the heat converging path.

16. The lithium-ion soft battery of claim 1, wherein the at least two heat conducting and collecting bodies are recessed with respect to the negative electrode plate, an interconnecting portion is formed between the at least two heat conducting and collecting bodies and the negative electrode plate, a thickness of an entirety of each of the at least two heat conducting and collecting bodies is same as of a thickness of the interconnecting portion.

17. The lithium-ion soft battery of claim 1, wherein a temperature sensor is disposed on the at least one heat converging path.

18. The lithium-ion soft battery of claim 1, wherein the fluid-containing pipe is a pipe containing air conditioning refrigerant or a heat pipe.

19. The lithium-ion soft battery of claim 1, further comprising a plurality of fins disposed in the fluid-containing pipe.
